(19) United States
(12) Patent Application Publication
(10) Pub. No.: US 2019/0234559 A1
(43) Pub. Date: Aug. 1, 2019

(54) METHOD AND SYSTEM TO MONITOR AND SHUT DOWN SAW

(71) Applicant: HOLLYMATIC CORPORATION, Countryside, IL (US)

(72) Inventors: Victor GUYNN, Romeoville, IL (US); David W. Baarman, Fennville, IL (US)

(73) Assignee: HOLLYMATIC CORPORATION, Countryside, IL (US)

(21) Appl. No.: 16/260,512

(22) Filed: Jan. 29, 2019

Related U.S. Application Data
(60) Provisional application No. 62/624,164, filed on Jan. 31, 2018.

(51) Int. Cl. F16P 3/14; B27G 19/02; B23D 59/00; B27B 5/38

(52) U.S. Cl. CPC F16P 3/142; B27B 5/38; B23D 59/002; B27G 19/02

(57) ABSTRACT

A system and method relating to a saw system, the saw system including a saw blade configured for cutting, a shaft connected to the saw blade, a motor configured to rotate the saw blade by rotating the shaft, and at least one processor configured to control the motor. The saw system further comprising a detector configured to detect when a body part of a person is adjacent to or touching the saw blade. The at least one processor is configured to control the motor to stop rotation of the saw blade in response to the detector detecting that the body part is adjacent to or touching the saw blade. The saw blade including at least one hole that is filled with a weight-reduction insert.

### RELATED APPLICATIONS

The present application claims priority to U.S. Provisional Application No. 62/624,164, filed on Jan. 31, 2018, the contents of which are incorporated herein by reference in their entirety. The entire contents of U.S. Provisional Application No. 62/464,746, filed Feb. 28, 2017, are also incorporated herein by reference.

### BACKGROUND

### Technical Field

Embodiments relate to systems, methods, and apparatuses for stopping a saw and monitoring a blade that may come into contact with human body parts.

### Description of Related Art

Systems in a related art may comprise methods such as detecting the resistance of skin and mechanically thrusting the blade of a saw into a nylon barrier, which in turn stops the blade. The mechanical grabbing of the blade either damages the blade or destroys the blade and this may be undesirable. Other systems may use cameras as a visual means to detect the presence of an operator. Another system may utilize a conductive method based on skin resistance. It should be noted that cutting conductive materials creates issues for such systems discussed above.

Cutting conductive materials like aluminum or meat raises issues requiring special provisions and consideration. U.S. Pat. No. 7,924,164 B1 issued to Staerzl shows an example of a visual system that monitors a body part and a zone triggering a shut-down event. Although the visual system may be helpful for training and tracking proximity, it has use and resolution limitations in a dirty environment where gloves, cameras, and equipment can become covered in blood, meat, and liquids. It should also be noted that with fast moving parts and actions, reaction times for vision-based systems present a challenging issue.

In a related art system, some saws may apply mechanical brakes, or actually grab the blade mechanically and cause damage to the blade.

In a related art, some saws and safety systems use guards and light bars to create safe operating zones. Other systems may use an alarm or emergency stop. However, due to the time to shut down the blade, or due to the speed of reaction, the motor in such systems continues to spin and allows many further revolutions of the blade that may cause harm to a user. For example, in a related art automatic stop saw system employing mechanical braking, the time to stop the saw may be about 0.5 seconds. Thus the, saw could cut through a person easily due to its remaining inertia. At present, it may be possible to compensate for operator incompetence with safe and injury free operation, but this generates a new problem.

Related art saws used for cutting poultry may include an entry point aperture with a guard allowing only long and slim objects to enter. However, a saw operator's fingers can easily enter into the aperture and become injured.

Some problems of the related art technologies relate to masking of the image viewed with a camera in a meat-cutting environment. The production environment has many challenges with blood, bone, liquids and color changes for visual recognition of an object. This environment also creates issues with conductive materials as meat may have some material properties similar to that of human limbs. This makes it difficult to discern the difference between meat and human limbs when cutting.

Another issue with related art technologies includes repetition and training. Past solutions have not sought to track and train each user for a specific job and rank the propensity for a user to do a given job.

### SUMMARY

The present disclosure addresses several matters such as those described above, and other matters not described above. Embodiments of the present disclosure may be considered key solutions to past problems that have been observed and modified for better results in the production environment.

Systems, methods, and apparatuses for stopping a saw according to embodiments of the disclosure may be applicable to an automatic-stop safety system using motor driven machinery which drives, for example, the blade of a saw.

In an embodiment, a saw system is provided that comprises a saw. The saw comprises a saw blade configured for cutting, the saw blade including at least one hole that is filled with a weight-reduction insert. The saw further comprises a shaft connected to the saw blade; a motor configured to rotate the saw blade by rotating the shaft, at least one processor configured to control the motor, and a detector configured to detect when a body part of a person is adjacent to or touching the saw blade. The at least one processor is configured to control the motor to stop rotation of the saw blade in response to the detector detecting that the body part is adjacent to or touching the saw blade.

In an embodiment, the detector is a metal detector having a metal detection area in a location where a hand may travel towards the saw blade. The metal detector is configured to send an output signal to the at least one processor, based on presence of metal in the metal detection area of the metal detector. The saw system further comprises a glove comprising metal that is detectable by the metal detector when the glove is present in the metal detection area of the metal detector, and the at least one processor is configured to control the motor to stop rotation of the saw blade, before the glove contacts the saw blade, in response to the metal of the glove being detected by the metal detector.

In an embodiment, the glove comprises a conductive glove layer that is electrically connected to the at least one processor. The saw blade is electrically isolated from an electrical ground on a pathway through the saw. The glove and the saw blade are configured to, in response to the glove contacting the saw blade, complete an electrical circuit that includes a pathway through the saw blade and the glove. Also, the at least one processor is configured to control the motor to stop rotation of the saw blade in response to the electrical circuit being completed.

In an embodiment, the at least one processor is configured to determine that the glove is on a body of a person by reading an electrical resistance of the body.

In an embodiment, the saw system further comprises a camera directed at a cutting area of the saw blade and configured to send image data to the at least one processor. The glove further comprises a colored glove layer, the colored glove layer configured to surround the conductive glove layer. The at least one processor is further configured to detect the colored glove layer in the image data sent by the camera, and control the motor to stop rotation of the saw blade in response to the colored glove layer being detected within a predetermined area of the image data.

In an embodiment, the colored glove layer has a green color. In an embodiment, the colored glove layer is an electrically insulating glove layer. In an embodiment, the electrically insulating glove layer has an electrical resistance that is lower than an electrical resistance of a body of a person or lower than an electrical resistance of meat that the saw blade is configured to cut. In an embodiment, the motor is a direct-drive motor, and the motor is further configured to stop the saw blade in less than 20 ms.

In an embodiment, a method is provided, the method comprising detecting, with a detector, a body part of a person that is adjacent to or touching the saw blade, and controlling, with the at least one processor, the motor to stop rotation of the saw blade, in response to the detector detecting that the body part is adjacent to or touching the saw blade.

In an embodiment, the detector is a metal detector having a metal detection area in a location where a hand may travel towards the saw blade. The detecting comprises detecting, with the metal detector, a glove comprising metal that is present in the metal detection area of the metal detector, and the controlling comprises controlling, with the at least one processor, the motor to stop rotation of the saw blade before the glove contacts the saw blade, in response to the metal of the glove being detected by the metal detector.

In an embodiment, the method further comprises controlling, with the at least one processor, the motor to stop rotation of the saw blade in response to the electrical circuit being completed. The electrical circuit includes the pathway through the saw blade and the glove. The method further comprises controlling, with the at least one processor, the motor to stop rotation of the saw blade in response to the electrical circuit being completed.

In an embodiment, the method further comprises determining, with the at least one processor, that the glove is on a body of a person by reading an electrical resistance of the body.

In an embodiment, the method further comprises sending, with a camera directed at a cutting area of the saw blade, image data to the at least one processor. The method further comprises detecting, with the at least one processor, the colored glove layer in the image data sent by the camera. Also, the method further comprises controlling, with the at least one processor, the motor to stop rotation of the saw blade in response to the colored glove layer being detected within a predetermined area of the image data.

### DESCRIPTION OF DRAWINGS

A brief description of some representative drawings is provided as follows.

FIG. 1 illustrates a side view of a saw of an embodiment;

FIG. 2 illustrates a rear view of the saw of FIG. 1, where a front guard and a back guard is removed;

FIG. 3 illustrates another view of the saw of FIG. 2, showing a glove interface and motor of the saw;

FIG. 4 illustrates another view of the saw of FIG. 1, showing a ground insulator of the saw;

FIG. 5 illustrates another view of the saw of FIG. 2, showing a cavity where meat enters for processing after being cut by a blade of the saw.

FIG. 6 illustrates an embodiment of a blade of a saw.

FIG. 7 illustrates a chain of control when stopping a blade of a saw of an embodiment.

FIG. 8 illustrates an embodiment of a dynamic brake of a saw.

FIG. 9 illustrates an impedance detection glove system of a safety saw system.

FIG. 10 illustrates a vision system of a safety saw system.

FIG. 11 illustrates gloves of a safety saw system.

FIG. 12 illustrates an embodiment of a glove system that comprises a device that may mount on, for example, a belt of a user, and allows the user connection to a safety saw.

FIG. 13 illustrates another embodiment of a glove system in which gloves are directly connected to a saw monitor system of a saw.

FIG. 14 illustrates another embodiment of a glove system in which gloves include additional connections.

FIG. 15 illustrates a safety saw system of an embodiment.

FIG. 16A illustrates a first part of a startup process of an embodiment for checking all systems before starting a saw;

FIG. 16B illustrates a second part of a startup process of an embodiment for checking all systems before starting a saw;

FIG. 17A illustrates a process monitoring loop of an embodiment when a saw is running;

FIG. 17B illustrates a process monitoring loop of another embodiment when the saw is running;

FIG. 17C illustrates a process monitoring loop of another embodiment when the saw is running;

FIG. 18 illustrates information of zones and performance that may be recorded by a safety saw system for performance and safety rating purposes;

FIG. 19 illustrates information of zones and performance that may be recorded by a safety saw system for performance and safety rating purposes; and

FIG. 20 illustrates a data tracking method of the safety saw system.

FIG. 21 illustrates an embodiment in which a saw has connectivity.

FIG. 22 illustrates a metal detection system of an embodiment.

### DESCRIPTION OF EMBODIMENTS

In an non-limiting embodiment, there may be provided a saw for cutting meat. For example, the saw may be for cutting poultry. A saw system with the saw may include a user ID, metal detection, visual detection, and blade touch detection for optimum safety and tracking. According to some non-limiting embodiments, it becomes possible to quickly stop a saw while avoiding damage to particular components. Furthermore, it is possible to stop the saw without significant injury to a user, even if the user directly touches the blade of the saw with a conductive glove.

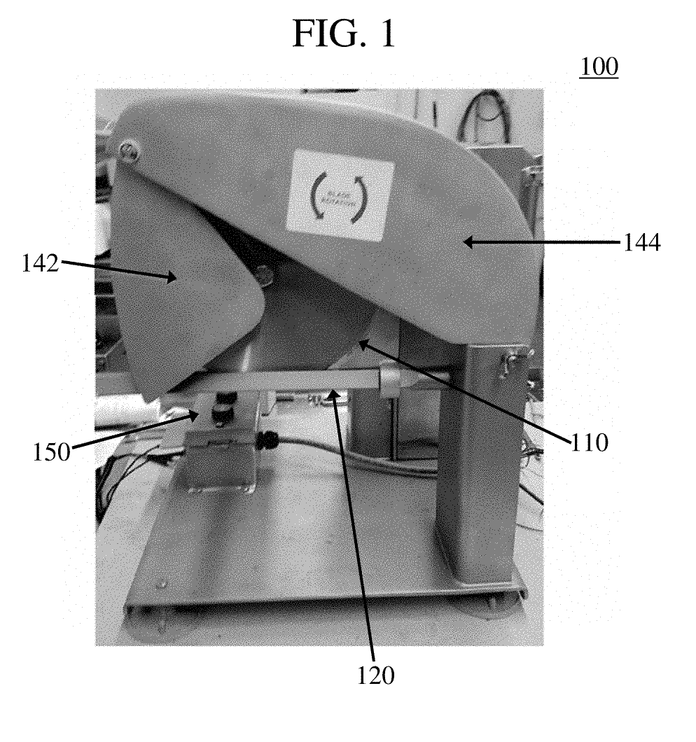

FIGS. 1-5 illustrate a saw 100 of the present disclosure.

As illustrated in FIG. 1, the saw 100 may include a blade 110 for cutting meat such as, for example, poultry. The blade 110 may be a circular blade. The blade 110 may be removable for easy cleaning. The saw 100 may also include a front guard 142 and a back guard 144 that protect a front and back of the blade 110, respectively. The front guard 142 and the back guard 144 may be guards of an automatic type. For example, the guards may automatically cover the blade when the saw 100 is stopped, thereby preventing a hazard to a user before starting the saw and when a stop condition is enabled. As such, injuries caused by a blade may be avoided when the saw 100 is stopped in preparation for a job. The front guard 142 may move towards the blade 110 when a front of the front guard 142 is pushed towards the blade 110 by an object to be cut, thereby exposing the blade 110 through the front guard 142 to cut the object. The blade 110 may be exposed through an aperture (not shown) of the front guard 142.

The saw 100 may also include a saw guide 120 that guides a bottom edge of the blade 110 and guards the bottom edge of the blade 110 from being touched by a user. The saw 100 may further include various buttons and switches, including buttons 150 for starting or stopping an operation of the blade 110 of the saw 100.

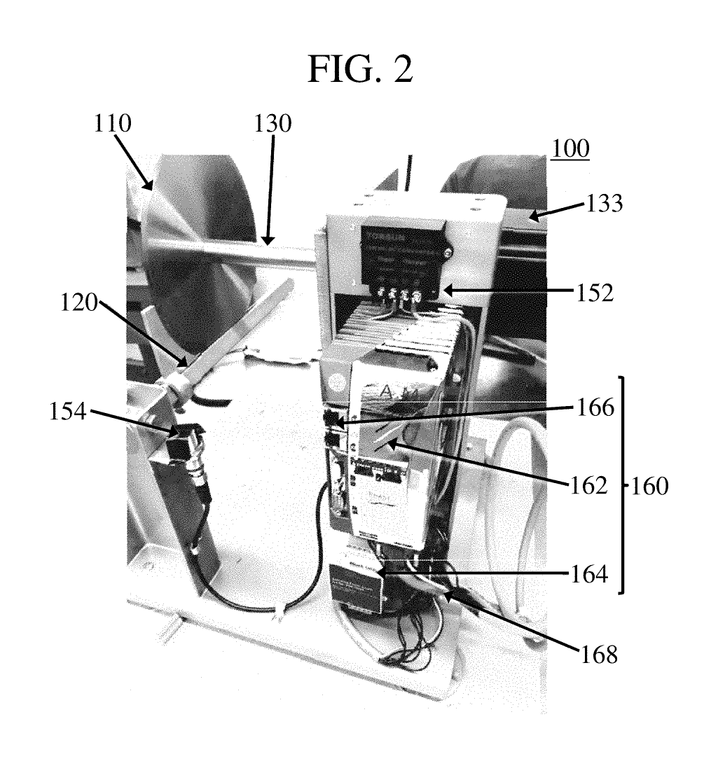

As illustrated in FIG. 2, the saw 100 may also include a shaft 130 that is connected to the blade 110, and a motor 133 that rotates the shaft 130 to cause the blade 110 to rotate. The saw 100 may also include an operation system 160 that receives various input signals, including sensor data and command inputs, determines how moving components of the saw 100 are to be operated based on the input signals, and causes the moving components of the saw 100 to operate in the determined manners. One example of the command inputs received by the operation system 160 may be an input from buttons 150. The operation system 160 may also control identifiers such as, for example, LEDs to turn on and off to indicate an operation state of the saw 100, and may have wired or wireless connectivity to computing devices, including local computing devices and a cloud computing system. The moving components of the saw 100 that may be controlled include, but are not limited to, the blade 110, the front guard 142, and the back guard 144. The saw 100 may also include a guard proximity switch 154.

The operation system 160 may include, for example, a motor controller 162, a programmable controller 164, and a network interface 166. The motor controller 162 may control the motor 164 that rotates the blade 110, and may function as a servo drive. The programmable controller 164 may function to receive the various input signals, including sensor data and command inputs, determine how the blade 110 is to be operated based on the input signals, and cause the motor controller 162 to control the blade 110 in the determined manner. The programmable controller 164 may also control other moving components of the saw 100. The operation system 160 may also include a network interface 166 that functions as a communication interface between components of the operation system 160, such as the programmable controller 164, and other computing devices, including local computing devices via wired and wireless local networks, and a cloud computing system via the internet.

The saw 100 may include a power supply 152 that supplies power to the operation system 160 and actuators of the saw 100, including motor 133. The power supply 152 may receive the power from input power 168. The operation system 160 and actuators of the saw 100 may also directly receive the input power 168.

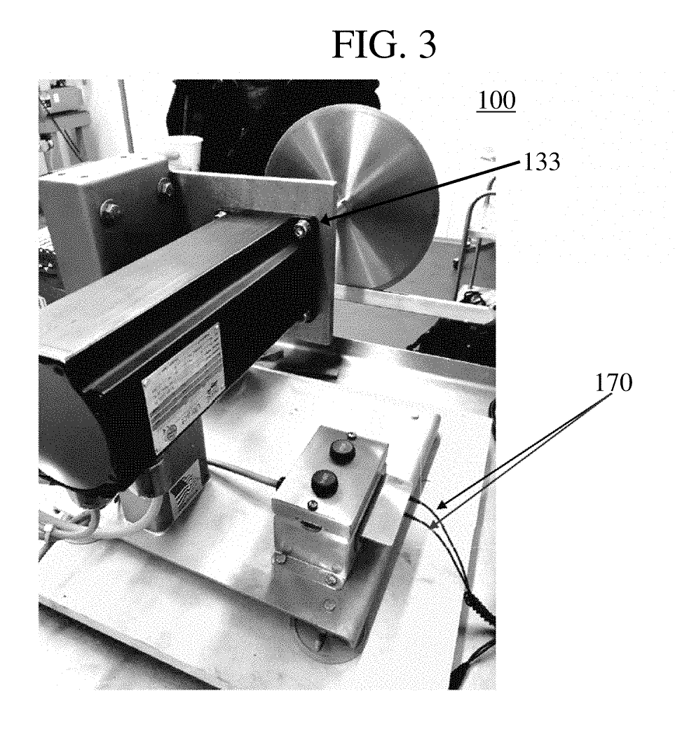

As illustrated in FIG. 3, the saw 100 may include glove interface connections 170 that are connected to the operation system 160, and that enable connected glove systems to send input signals to the operation system 160. Examples of such glove systems and gloves are described in detail further below.

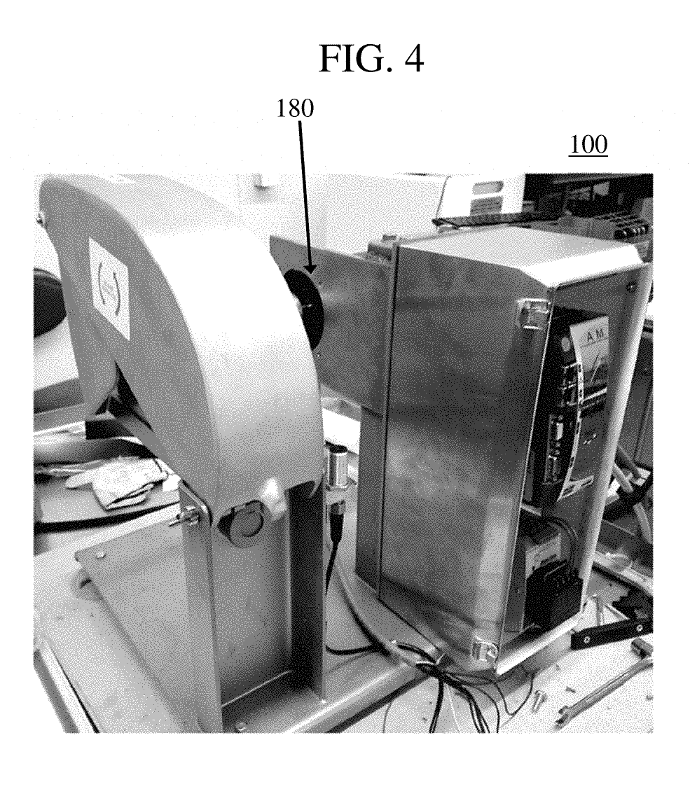

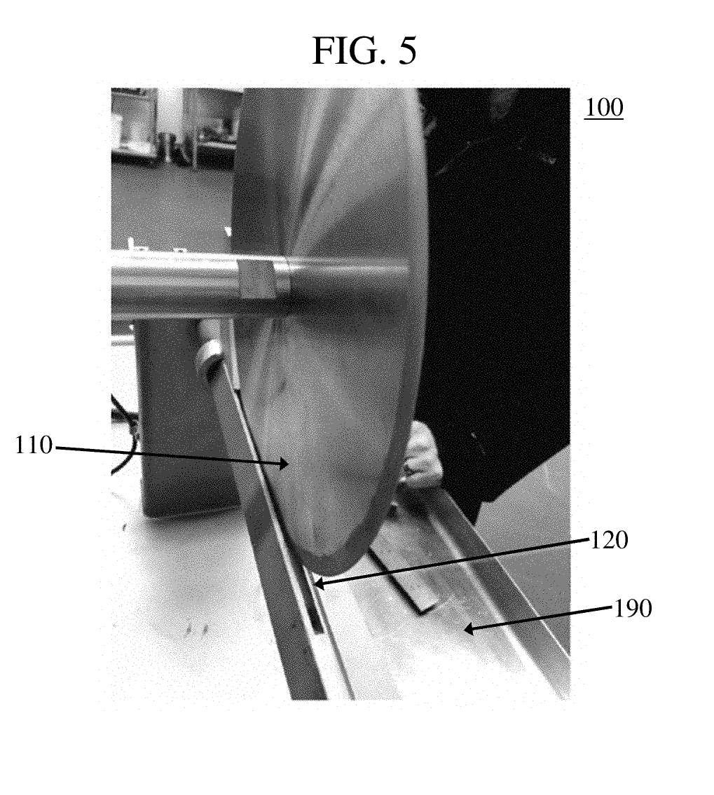

As illustrated in FIG. 4, the saw 100 may include a ground insulator 180 that electrically insulates the shaft 130 and the blade 110 from a ground. As illustrated in FIG. 5, the saw 100 may include a cavity 190, below the saw guide 120, where meat enters for processing after being cut by the blade 110.

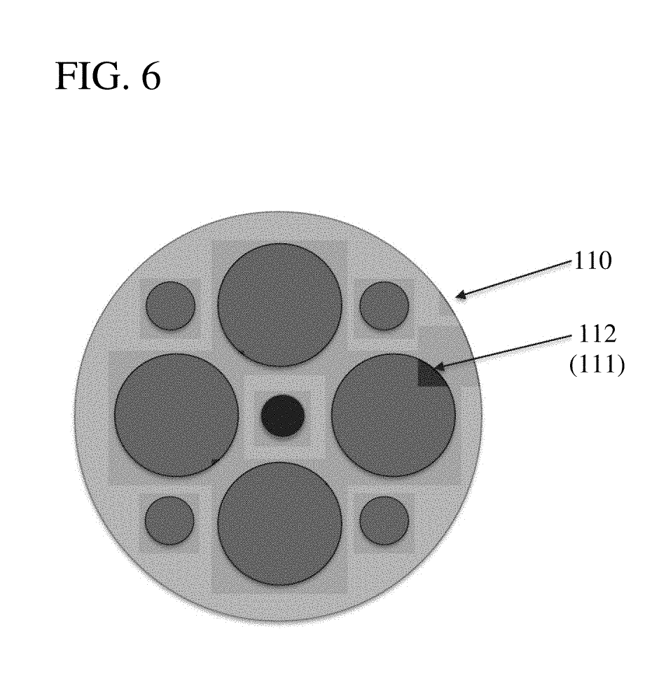

As illustrated in FIG. 6, the blade 110 may include holes 111 that are filled or covered with inserts 112 that enable the blade 110 to have a low inertia. The inserts 112 may be, for example, weight reduced epoxy or plastic inserts. Alternatively, the holes 111 of the blade 110 may be covered with a very thin, weight reduced plate to prevent cleaning issues with the blade 110. For example, the blade 110 may be milled to include a cavity on both sides of the blade 110 such that end plates may be inserted in and welded to the blade 110 to prevent food collection. The end plates may have a similar position and shape as the positions and shapes of the inserts 112 illustrated in FIG. 6. The blade 110 with end plates and hollow cavities is a blade with reduced weight and comparable strength, as compared to blades without hollow cavities and end plates. The blade 110 of the saw 100 may be designed to operate with high torque and engage an object with friction such that the object is pulled in, sliding along the saw guide 120, while the blade 110 cuts the object.

The shaft 130 may be a hollow shaft. Accordingly, the blade 110 and the shaft 130 may each have low inertia. The shaft 130, including its connection hardware, may be a part of an inertial calculation. Making the shaft 130, including its connection hardware, lighter has a major impact on stopping times of the blade 110. The shaft 130, including its connection hardware, can also be isolated from a system ground to enable a circuit in a glove system to work independently from the system ground. For example, the shaft 130, and its connection hardware, may be isolated with the ground insulator 180, illustrated in FIG. 4, and the shaft 130 and the blade 110 may carry a small AC signal or frequency for use in touch detection with a glove system, as discussed further below.

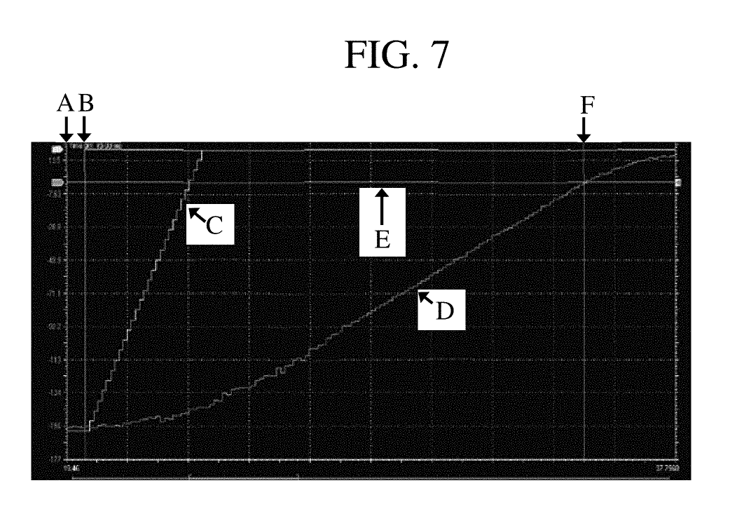

In an embodiment of the present disclosure having a circular blade and a shaft with reduced weight and low inertia, a travel distance of the circular blade may be very short during braking. That is, for example, a saw of the present disclosure that includes a 9 in diameter blade moving at 1500 RPM may be stopped in 0.01503 seconds, which is equivalent to 135.3 degrees or 10.62 inches of travel. FIG. 7 illustrates a chain of control demonstrating that a saw of the present disclosure with a 9 in diameter blade stops in 0.01503 seconds.

With respect to FIG. 7, the horizontal axis corresponds to time and the vertical axis corresponds to a rotating speed of a blade and a motor controlling the blade. Reference character “A” indicates a time in which the motor controls the blade at a normal operation speed. Reference character “B” indicates a time of an event, specifically a glove touching the blade of the saw, that triggers the saw to control the motor and the blade to stop. Such event is considered to occur at a reference time of 0.00 milliseconds. Reference character “C” indicates a line representing the command speed for the motor, and reference character “D” indicates a line representing the actual speed of the motor. Reference character “E” indicates a horizontal line representing a rotating speed of 0 radians/second, and reference character “F” indicates the breaking time of the motor of 15.03 milliseconds, from the reference time (time of the event), in which the motor and the blade stop rotating.

Stopping time is a critical function of a system of the present disclosure. It is assumed that a stopping time of 0.1 seconds is plenty fast enough that an operator would not be injured. Some AC motors, permanent magnet motors, and servo motors, cannot achieve a machine stop time of under 0.1 second. However, after calculations and experimentation by the inventor, a solution was found with a specific type of motor and gear box. A motor of the present disclosure includes very low inertia, and a motor and gearbox of the present disclosure are able to output enough torque to stop without being damaged in the process.

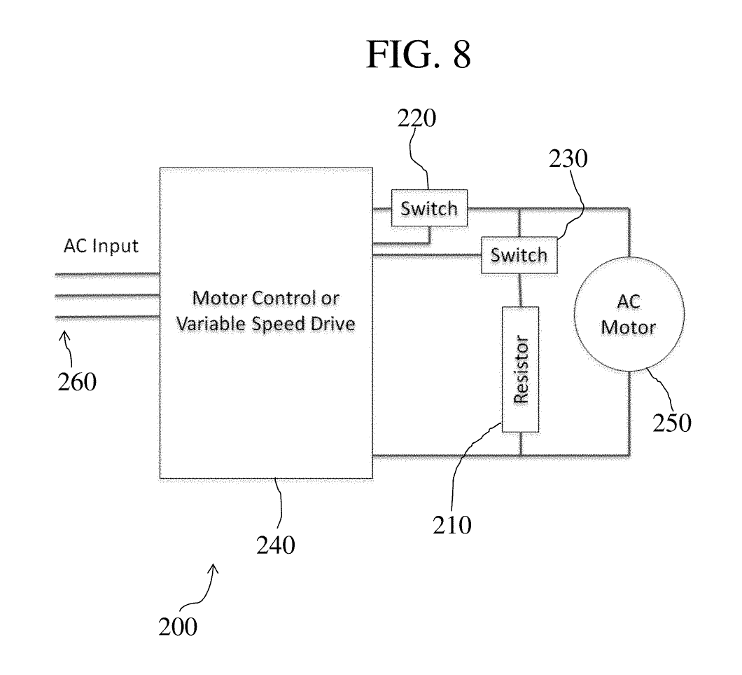

For example, the saw 100 may use a direct drive motor as the motor 133 to rotate a blade, such as blade 110. By eliminating the gear box and going to a direct drive motor, the saw 110 may reduce inertia and reduce stopping times. With reference to FIG. 8, a dynamic braking system 200 that may be included in the saw 100 is described, in which brake performance can be achieved using blade 110 and the shaft 130. Dynamic breaking system 200 comprises, for example, an AC input 260, a motor control or variable speed drive 240, switches 220, 230, load resistor 210, and an AC motor 250, as the motor 133. The motor control or variable speed drive 240 receives power supplied from the AC input 260 and controls the AC motor 250.

On nearly all gearboxes that can be standard ordered, the gearboxes are only offered with steel shafts. Since the saw 100 may be direct driven from an output shaft, and the output shaft may be exposed to wash down and very caustic chemicals, the shaft and carrier assembly may be made with specialized components. For example, the shaft and carrier assembly may be made from proprietary stainless steel parts from Hollymatic to meet the inertial specifications.

The saw 100 may use, in addition to dynamic breaking spring sets, magnetic braking for even lower braking times. The KEB magnetic braking system is a good example of an additional magnetic spring set clutch that can be engaged to act as an additional brake to help stop the saw 100 faster. The pre-tensioned springs may be held back with a magnet that is energized while the motor 133 is in use. When the motor 133 is required to break the magnet, power is released and the springs brake the motor 133 in addition to the dynamic braking for maximum stopping times.

In a related art saw system employing mechanical brakes, the time to stop the saw may be about 0.5 seconds. However, in an embodiment of the present disclosure, because the machinery is driven by a specialized motor system, the safety saw system of the present disclosure is able to stop a blade in a time of less than 0.05 seconds. For example, a motor of the present disclosure, which is directly coupled to a blade 110 of the saw 100 through a direct drive, allows for precise control of the angular position, velocity, and acceleration of the blade 110 and can thus stop the blade 110 nearly instantaneously.

Saw stop calculations and steps are listed below and require no mechanical blade grabbing as related art technologies have used in efforts to achieve fast braking. It is noted that operational up time and blade damage are concerns with mechanical grabbing of a saw blade.

Specifications for a dynamic breaking system 200 of an embodiment may be determined, for example, by the following saw stop calculations and steps. By determining the specifications via the described saw stop calculations and steps, fast breaking may be achieved without using mechanical blade grabbing that has been implemented in related art technologies in attempt to achieve fast breaking. Accordingly, the issues of reduced operational up time and increased blade damage that occur with mechanical blade grabbing of a saw blade may be better avoided.

Step 1—Determine the Total Inertia

J_{T}=Total inertia reflected to the motor shaft, kilogram-meters², kg-m², or pound-feet², lb-ft²

Jₘ=motor inertia, kilogram-meters², kg-m², or pound-feet², lb-ft²

GR=The gear ratio for any gear between motor and load, dimensionless

J_{L}=load inertia, kilogram-meters², kg-m², or pound-feet², lb-ft² (1.0 lb-ft²=0.04214011 kg-m²)

Step 2—Calculate the Peak Braking Power

J_{T}=Total inertia reflected to the motor shaft, kg-m²

ω=rated angular rotational speed,

N=Rated motor speed, RPM

t₃−t₂=total time of deceleration from the rated speed to 0 speed, seconds

P_{b}=peak braking power, watts (1.0 HP=746 Watts)

Compare the peak braking power to that of the rated motor power, if the peak braking power is greater than 1.5 times that of the motor, then the deceleration time, (t₃−t₂), needs to be increased so that the drive does not go into current limit. Use 1.5 times because the drive can handle 150% current maximum for 3 seconds.

Peak power can be reduced by the losses of the motor and inverter.

Step 3—Calculating the Maximum Dynamic Brake Resistance Value

V_{d}=The value of DC bus voltage that the chopper module regulates at and will equal 375 Vdc, 750 Vdc, or 937.5 Vdc

P_{b}=The peak braking power calculated in step 2

R_{db1}=The maximum allowable value for the dynamic brake resistor

The choice of the Dynamic Brake resistance value should be less than the value calculated in step 3. If the value is greater than the calculated value, the drive can trip on DC bus overvoltage. Resistor tolerances may also be accounted for.

Step 4—Determine the Minimum Resistance

Each drive with an internal DB IGBT has a minimum resistance associated with it. If a resistance lower than the minimum value for a given drive is connected, the brake transistor will most likely be damaged.

Step 5—Choosing the Dynamic Brake Resistance Value

To avoid damage to this transistor and to get the desired braking performance, a resistor with a resistance between the maximum resistance calculated in step 3 and the minimum resistance of the selected chopper module is selected.

Step 6—Estimating the Minimum Wattage requirements for the Dynamic Brake Resistor

It is assumed that an application exhibits a periodic function of acceleration and deceleration. If (t₃-t₂)=the time in seconds necessary for deceleration from rated speed to 0 speed, and t₄ is the time in seconds before the process repeats itself, then the average duty cycle is (t₃−t₂)/t₄. The power as a function of time is a linearly decreasing function from a value equal to the peak regenerative power to 0 after (t₃-t₂) seconds have elapsed. The average power regenerated over the interval of (t₃-t₂) seconds is P_{b}/2. The average power in watts regenerated over the period t₄ is:

Pₐᵥ=Average dynamic brake resistor dissipation, in watts

t₃−t₂=Elapsed time to decelerate from rated speed to 0 speed, in seconds

t₄=Total cycle time or period of process, in seconds

P_{b}=Peak braking power, in watts

The Dynamic Brake Resistor power rating in watts that is to be chosen may be equal to or greater than the value calculated in step 6.

Step 7—Calculate the required Watt-Seconds (joules) for the resistor

In order the ensure that the resistors thermal capabilities are not violated, a calculation to determine the amount of energy dissipated into the resistor may be made. This may determine the amount joules the resistor must be able to absorb.

P_{ws}=Required watt−seconds of the resistor

t₃−t₂=Elapsed time to decelerate from ω_{b} speed to ω₀ speed, seconds

P_{b}=Peak braking power, watts

Actual cutting and movement frictions and the addition of spring set magnetic braking combined with dynamic braking can reduce the actual saw movement to just several inches to provide maximum safety.

In a non-limiting embodiment, a safer saw is provided that operates with the same ease as a standard saw which all of the operators in plants are currently used to. In a safety saw of the related art, it takes a great deal of time to start operation of a saw due to the required person protective equipment (PPE), mental taxation due do the violence of stopping the saw, and erratic stopping or false stopping of the saw. A saw and control system of at least one embodiment of the present disclosure may only require conductive gloves, colored rubber gloves, or colored rubber gloves over conductive gloves. In contrast, other saws may require an operator to use several pairs of gloves and new boots with no holes, and for the operator to have no perspiration or moisture in their clothing. Further, other saws may require the operator to stand on a grate to isolate themselves from any grounding, due to the whole body sensing of an electrode being used.

In an automatic-stop safety saw and safety system of the present disclosure, there involves a safety system for machinery in which some input to a controller, for example the programmable controller 164, triggers the sudden stop of a component of the machinery, for example the blade 110 of the saw 100.

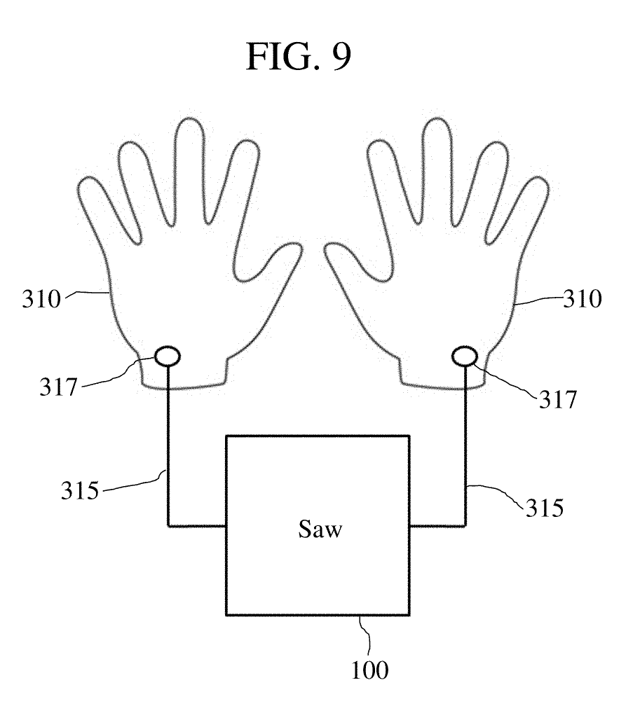

With reference to FIG. 9, the safety system may be an impedance detection glove system that may be used in discerning the present impedance of a human or meat is described.

In the saw 100, an input signal to the programmable controller 164 may be caused by the closure of an electrical circuit due to physically touching the blade 110, which is metallic, with at least one of the electrically conductive gloves 310. The electrically conductive gloves 310 may comprise interwoven conductive fibers. As illustrated in FIG. 9, the gloves 310 may be connected to a tether 315 via conductor 317, wherein the tether 315 is further connected to the saw 100 and thereby completes a circuit with the saw blade 110 when a user of the gloves 310 touches the blade 110 of the saw 100. Alternatively, the gloves 310 may be connected to a tether 315 via a conductor 317, wherein the tether 315 is attached to the user's clothing (for example, a butcher's smock) and then continues to the saw 100. If a user wearing the gloves 310 touches the saw blade 110, the controller 164 causes the blade 110 to stop in time so that the user is not severely injured and the saw 100 is not damaged. A concept behind the conductive stop is to allow one to a discern a voltage that represents the glove coming into contact with the ground, in contrast to meat or wet environments.

The circuit across the two gloves 310 may represent a bio impedance and can indicate the presence of a worker to initiate calibration and proper operation. Insulators, such as ground insulator 180, can be used to electrically isolate a drive mechanism, such as the shaft 130, from the body of the saw 100. Accordingly, the blade 110 may be electrically detectable.

Alternatively or additionally, the gloves 310 may be used to cause the blade 110 to stop before the user touches the blade 110. For example, the gloves 310 may include metal such that the gloves 310 may be detected as a metal object in an entryway to the blade 110. That is, a metal detection system may detect the gloves 310 as a metal object, thereby causing the blade 110 to stop before a hand of the user is pulled into a mechanism, including the blade 110. By placing the metal detection system adjacent to an entry point to the blade 110, such as at the front of the blade 110 where meat may be cut, and shielding the detector circuit from detecting metal in certain directions, the metal detection system may be configured to detect metal at the entry point and a detection threshold can be selected. The gloves 310 can also be loaded with metal to obtain a specified threshold for metal detection of the gloves 310 by the metal detection system. The fingertips of the gloves 310 can be proportionally loaded with metal material for detection. In view of the above, the gloves 310 may be both conductive, for detecting the gloves 310 when they touch the blade 110, and include metal, for detecting metal in the gloves 310 when they are near an entryway to the blade 110, intrinsically at the same time within a dual safety system of the saw 100. Limits and thresholds of the safety system can be easily set and repeated. For example, the limits and thresholds for metal detection and conductive glove detection may be set in the controller 164 of the saw 100.

With some metal detection sensors and systems, a saw may not stop if the object being sensed is moving too fast. For example, a saw may not stop due to a relatively long total processing time of the sensor or system. To solve this issue, a metal detector system of the present disclosure may be used. For example, a metal detector system of the present disclosure may include a focused sensing field directed to the meat tunnel or entry point to the blade 110. The focused sensing field may be provided by using magnetic shielding in the metal detector system.

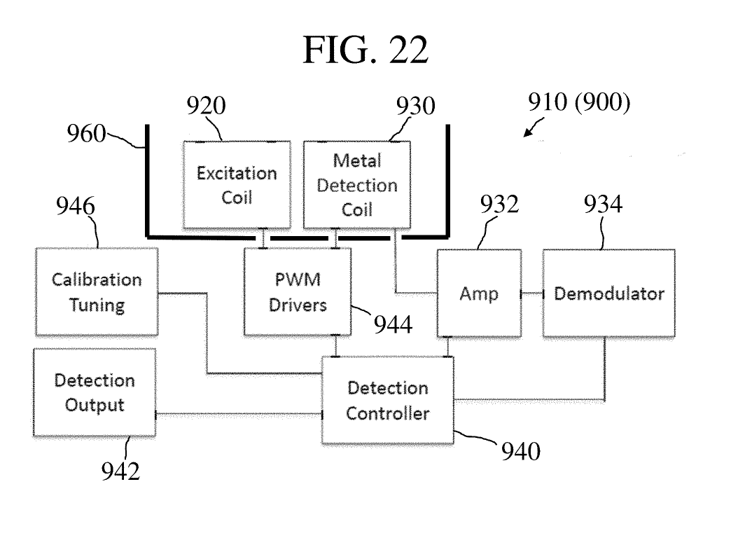

As illustrated in FIG. 22, the metal detector system 900 may include at least one detector 910. The detector may be of any type of metal detector known in the art. For example, the detector 910 may be of a technology using beat frequency oscillation (BFO), pulse induction (PI), or very low frequency (VLF). In an embodiment, the detectors 910 may be provided at one or more locations, including at the sides of the saw guide 120 and above the saw guide 120. The detectors 910 may be positioned at an entryway to the blade 110.

In an embodiment, the detector 910 may be configured to detect metal in a location by, for example, detecting a change in a magnetic field caused by the presence of metal in the location. The detector 910 may include an excitation coil 920 that produces a magnetic field when provided with an electric current, the magnetic field causing eddy currents to be induced in nearby metal, thereby causing the metal to also produce a magnetic field. The detector 910 may also include a metal detection coil 930 that detects a change in the magnetic field of an area caused when metal in the area is exposed to the magnetic field of the excitation coil 920. For example, the metal detection coil 930 may produce a corresponding voltage or other response based on the location of the metal with respect to the metal excitation coil 920 and the metal detection coil 930.

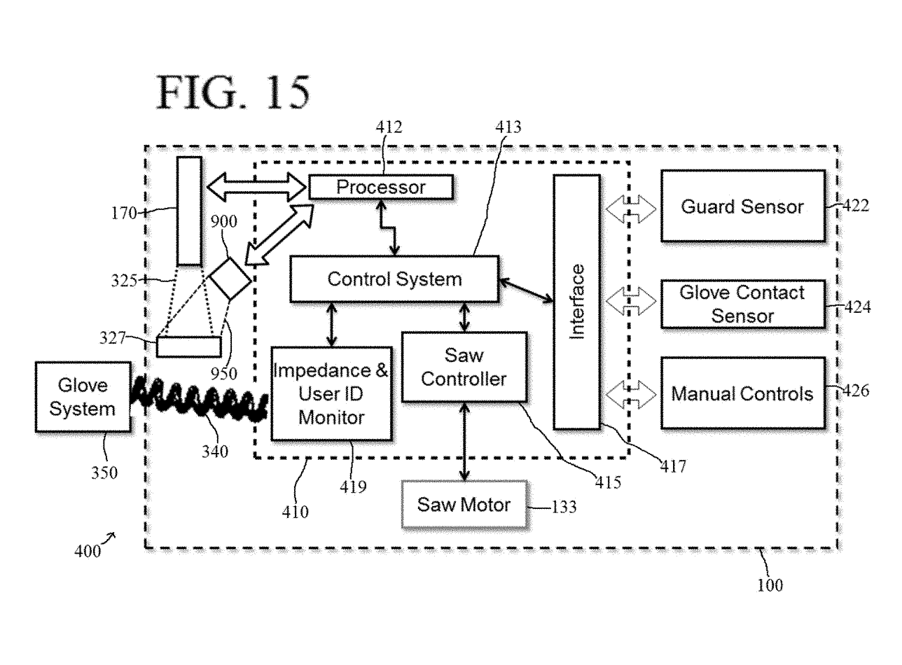

The detector 910 may include a detection controller 940, including at least one processor, that determines whether an output of the metal detection coil 930 corresponds with detection of the metal based on, for example, whether the output of the metal detection coil 930 to the detection controller is above a predetermined level. An amplifier 932 and a demodulator 934 may be used on an output side of the metal detection coil 930 to the detection controller 940. The detection controller 940 may output a metal detection result to a detection output 942, such as the controller 164 illustrated in FIG. 2. The detection controller 940 may be formed in or external to the detector 910. For example, when external, the detection controller 940 may be connected to a plurality of the detectors 910 to determine a metal detection result for each detector 910. The detection controller 940 may be integrated with or external to the metal detection system 900. The processor 412, described further below with respect to FIG. 15, may function as the detection controller 940 to one or more detectors 910 from outside the metal detection system 900.

PWM drivers 944 may also be included in the detector 910 for generating a pulse in the excitation coil 920 or the metal detection coil 930, depending on the type of metal detection technology used. The detection controller 940 may control the PWM drivers 944. The detector controller 910 may also receive a signal for calibration tuning 946.

The metal detector system 900 may also include shielding material 960 that provides magnetic shielding to at least one of the detectors 910. For example, the excitation coil 920 and the metal detection coil 930 may be within a shielding profile of the shielding material 960. In an embodiment, the shielding material may be integrated into or around the saw guide 120, or at other locations of the saw 100 where the detectors 910 are located. The shielding material may isolate a metal detection circuit of the detector 910 from metal within and around the saw guide 120, such that a detection area 950, as shown in FIG. 15, of the detector 910 is shaped. The detector 910 may be positioned and the shielding material 960 may be provided such that detector 910 detects the gloves 310 when the gloves 310 move to an entryway of the blade 110. The entryway of the blade 110 may be at an aperture of the saw 100 to the blade 110.

In a safety system embodiment of the present disclosure that includes a metal detector, the processing and output time of the safety system may be around 0.014 seconds and the embodiment may have a buffered output in case a scan misses closing a relay to give a stop signal for stopping the saw. The safety system may also detect if the metal detector is calibrated and, if the metal detector is faulted, will shut the saw off when certain conditions are not met. The safety system may record all of the positive hard stops of the saw and may be viewable to a supervisor or other qualified person.

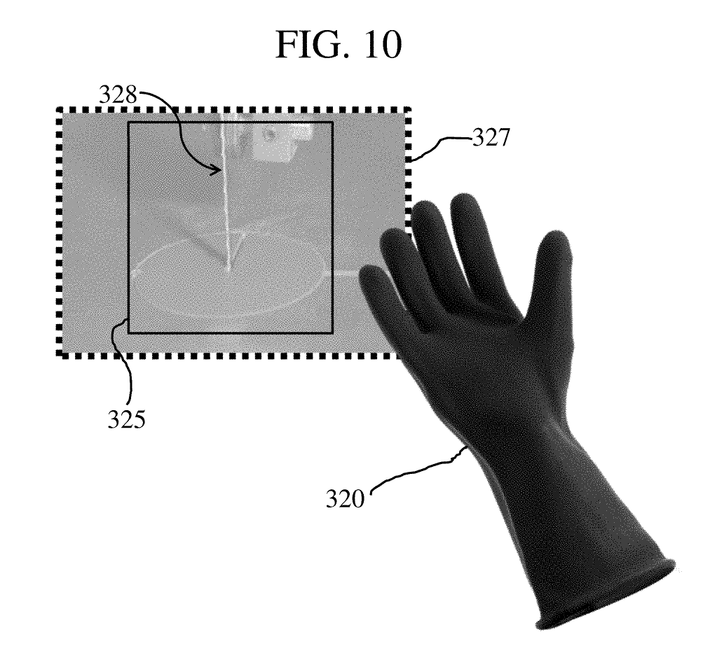

Alternatively or additionally, the input signal to trigger an automatic-stop of the saw 100 may be based on a visual cue. For example, a camera may detect when a colored glove 320 enters into a safety zone 325 of a saw blade 328, as illustrated in FIG. 10. Although the saw blade 328 is shown to be a band saw blade, the saw blade may alternatively be, for example, the blade 110 that is circular. A safety zone 325 may be, for example, a cutting path in a range of 2 inches or less in front of the saw blade. Alternatively, the safety zone 325 may be more than 2 inches from the front of the saw blade and may include any sized area around the saw blade. Surrounding the safety zone 235 may be a training zone 327. The colored glove 320 may be green so that it can be reliably distinguished from, for example, fat and veins in a meat product. However, the colored glove 320 may have any color that can be reliably distinguished from a product cut with the saw blade.

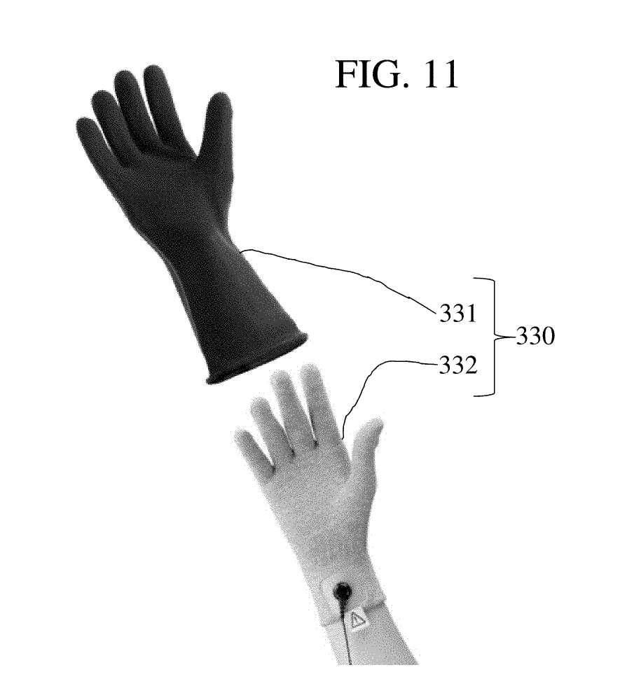

With reference to FIGS. 11-14, embodiments of other glove systems that may be used in a safety saw system are described.

To detect an operator while running product, and if a camera should not detect the operator or a colored glove when covered by the product, additional safety measures may be necessary.

Accordingly, as illustrated in FIG. 11, an embodiment of the disclosure may include a colored glove 331 and a conductive glove 332, corresponding to glove 310, to enable proper connections and insulation, wherein the conductive glove 332 is to be provided under a colored glove 331. Alternatively, the conductive glove 332 and colored glove 331 may be an inner layer and an outer layer of a single glove, respectively. The conductive glove 332 may include metal for metal detection. Hereinafter, the combination of the conductive glove and the color glove will be referred to as a glove 330. A user may wear a glove 330 on each hand when operating the saw 100. Using glove material that are suitable in the electronics and semiconductor industry may provide proper conductivity in the gloves 330.

A glove during initial tests had an ohm reading of 10 k ohms, which is around the same as a human hand. It was found that the voltage drop through this glove may be too significant and the machine may not sense it. For example, in an experiment, one sensing's fibers were burned out and would not sense any longer. Thus, in an embodiment of the disclosure, it is preferable that the glove 330 have an ohm reading across the glove 330 at 5 ohms or less. Also, it is preferable to be able to read a voltage in a glove system low enough that a human will not be harmed or feel anything when the glove 330 is conducting to a sensing unit. In order to do this, it may be preferable to have special low voltage inputs on the drive being used, the preferred drive sensing a voltage from 3.5 volts dc and up. This voltage is low enough that a human should not feel the voltage.

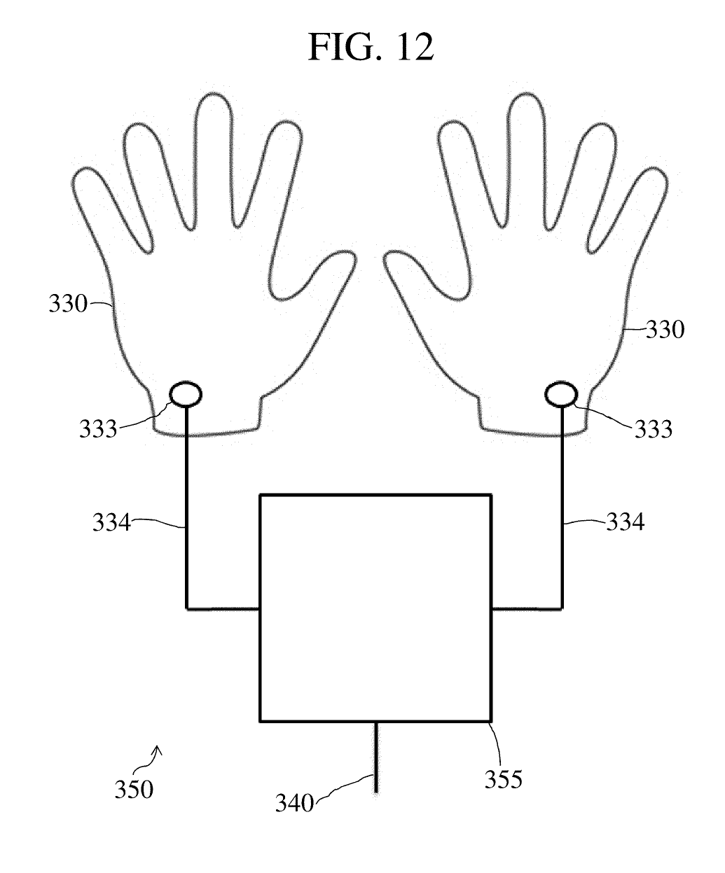

As illustrated in FIGS. 12-14, the gloves 330 may also be easily connected to and disconnected from a machine, such as saw 100. In order to do this, there may be provided snaps 333 connected to the gloves 330, respectively, and a specialized cable 334 that snaps onto the gloves 330 and plugs into the machine. Since the cable 334 is connected and has a possibility of coming into contact with other voltages, the gloves 330 may be fused with a 30 milliamp fuse. In such an embodiment, it can be easily detected when a fuse blows as the fuses may be visually inspected for breakage and because a circuit including the gloves 330 and the specialized cable 334 may be detected as having an open state when a closed state is expected. The machine may also shutdown if one of or both of the gloves 330 is missing from the circuit.

FIG. 12 illustrates a glove system 350 that comprises a device 355 that may mount on, for example, a belt of a user, and allows the user to be connected to the saw 100. The device 355 may include a processor and memory. The processor may output a user ID, glove status inputs, and other information to a saw, such as the saw 100 via a cable 340. The memory may store the user ID, glove status inputs, and the other information.

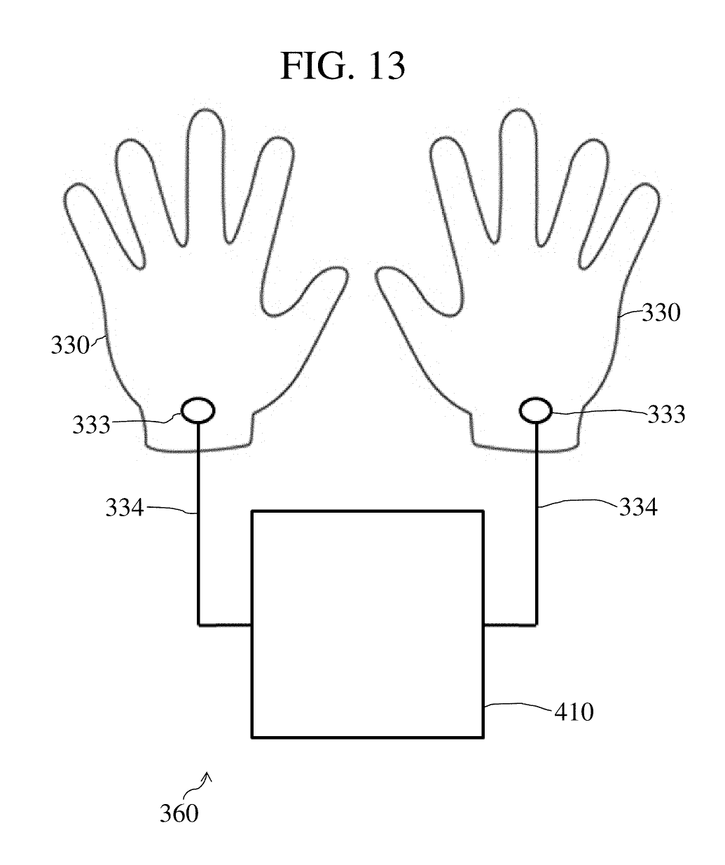

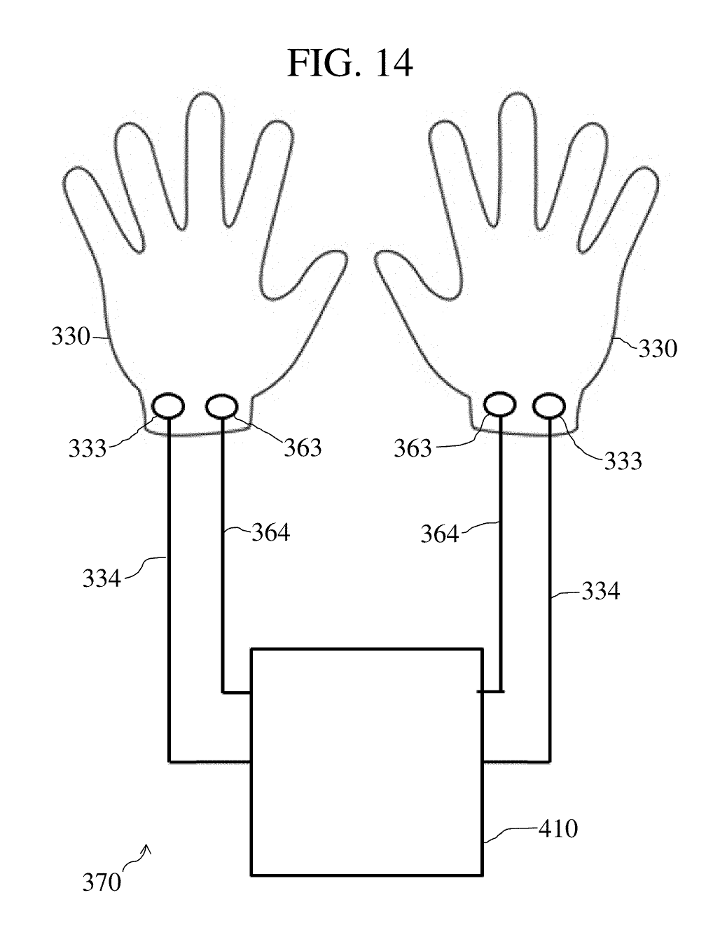

FIG. 13 illustrates a glove system 360 in which the gloves 330 are directly connected to a saw monitor system 410 of a saw, such as saw 100. FIG. 14 illustrates a glove system 370 in which the gloves 330 include additional connections 364 that are provided separately from the specialized cable 334 and with additional snaps 363. The additional connections 364 may provide lower resistance than an embodiment with the specialized cables 334 but that does not include the additional connections 364. The additional connections 364 may be redundant. Alternatively, the additional connections 364 may help verify that each glove is on independently. Also, instead of being provided separately from the specialized cable 334, the additional connections may be provided integrally with the specialized cable 334. The specialized cables 334 and additional connections 364 may directly connect the gloves 330 to the saw monitor system 410 of a saw, such as saw 100.

By using glove systems such as the ones described in FIGS. 9-14 with, for example, saw 100, the saw 100 may operate with the same ease as a standard saw in which all operators in plants are currently used to. Also, while FIGS. 12-14 illustrate glove systems that include gloves 330, the glove systems may alternatively use conductive gloves 332 without colored gloves 331, when visual detection of gloves is not used in a saw safety system.

With reference to FIG. 15, a safety saw system 400 of an embodiment of the disclosure that comprises saw 100 is described. Glove systems, such as the glove systems illustrated in FIGS. 10-15, may also be included in the safety saw system 400. Vision systems, such as the vision system illustrated in FIG. 10, may also be included in the safety saw system 400.

Safety saw system 400 may comprise the saw 100 and a glove system such as, for example, glove system 350. The saw 100 may comprise a saw monitor system 410 that includes a processor 412, control system 413, saw controller 415, interface 417, and impedance & user ID monitor 419. The saw monitor system 410 may be formed of at least one computer processor and memory. The saw 100 may further comprise at least one guard sensor 422, glove contact sensor 424, and manual controls 426. The manual controls may include start and stop buttons and emergency stop buttons.

The glove system 350 may be connected to the saw monitor system 410 by a cable 340 to supply user ID, glove status inputs, and other information to the impedance & user ID monitor 419. The impedance & user ID monitor 419 may determine the identity of a user that uses the glove system 350, based on the supplied user ID or other information supplied by the glove system 350 that indicates a user ID, and may further determine a state of the gloves 330 based on glove status inputs supplied from the glove system 350, including conductivity values.

The metal detection system 900 of the saw 100 may supply an input signal, such as sensor data, to the processor 412 to determine whether a glove 330 is detected in an entryway of the blade 110. The processor 412 may also detect whether the metal detection system 900 is faulted.

It is noted that, while the metal detection system 900 is shown to be above a detection area of the saw 100 and focused on a training zone 327, the metal detection system 900 may be at any location and have a detection area 950 of any angle and focus, with respect to the saw 100, so long as the metal detection system is positioned to detect a position of an operator before the operator touches the blade 110. For example, the metal detection system 900 may be below, above, or on a side of the blade 110 or the saw guide 120. Also, the metal detection system may be configured to have a detection area 950 that is away, toward, or parallel to the blade 110 or the saw guide 120. The metal detection system 900 may also include a plurality of sensing devices, such as detectors 910, that each include, for example, at least one coil for metal detection. The plurality of sensing devices may be positioned around the blade 110 and the saw guide 120 at varying positions and angles to increase the locations in which an operator is detected when they are too close to the blade 110.

Alternatively or additionally, a camera 170 may be included with the saw 100 and may supply image data to the processor 412, the image data may include images in which the gloves 330, the safety zone 325, the training zone 327, and an optical barcode corresponding to a user ID are captured. The processor 412 may determine an identity of a user of the glove system 350 based on detection of an optical barcode provided on gloves 330 of the glove system 350. The processor 412 may also determine whether the image data includes a visual cue that suggests a safety issue with respect to a user of the glove system 350 in their use of the saw 100. For example, the processor 412 may determine whether one of the gloves 330 enters within the safety zone 325. The processor 412 may also detect whether the camera 170 is covered or faulted. The processor 412 and the camera 170 may together be an ultra-high speed vision system wherein the processor 412 has a total processing and output time of, for example, around 0.014 s and a buffered output in case a scan misses closing a relay to give a stop signal. Accordingly, unlike other vision sensors and systems tested, the ultra-high speed vision system can cause the saw 100 to stop even when an object sensed by the camera 170 is moving fast.

The processor 412 may be a plurality of processors. For example, the processor 412 may include at least one processor that performs the functions of the processor 412 that are related to the camera 170, and may further include at least one processor that performs the functions of the processor 412 that are related to the metal detection system 900.

The interface 417 may interface the at least one guard sensor 422, glove contact sensor 424, and the manual controls 426 with the control system 413.

The control system 413 may be connected to the processor 412, interface 417, and impedance & user ID monitor 419 to determine whether the saw 100 should start or stop operation, based on inputs of the glove system 350, camera 350, and sensors and controls connected to the interface 417.

Operation of the saw 100 may be controlled by the control system 413 via the saw controller 415. The saw controller 415 may control operation of the motor 133 that causes movement of the blade 110 of the saw 100.

Additionally, the safety saw system 400 may also record all of the positive hard stops of the saw 100 and make information concerning saw usage viewable to a qualified person such as a supervisor.

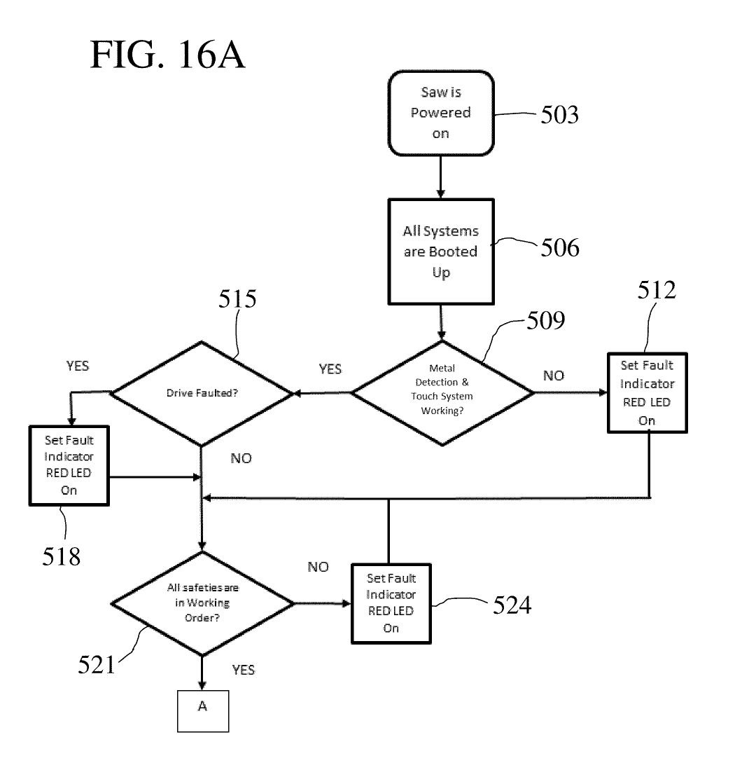

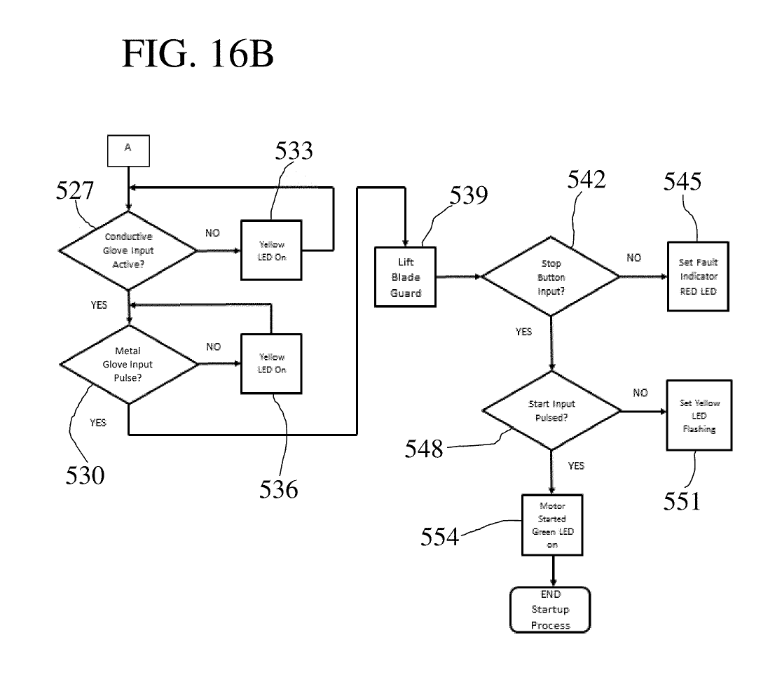

With reference to FIGS. 16A-B, an example startup process of the safety saw system 400 is described.

After the saw is powered on (step 503), all systems of the saw 100 including the saw monitor system 410 are booted up (step 506). Following, the processor 412 determines whether the metal detection system 900 and the conductive touch system of the gloves 330 is working (step 509). If at least one of the metal detection system 900 and the conductive touch system is determined to not be working, a fault indicator red LED may be set on (step 512) and the saw monitor system 410 checks whether all safeties of the saw 100 are determined to be working (step 521). If the metal detection system 900 and the conductive touch system is determined to be working, the saw monitor system 410 determines whether a drive of the saw 100 is faulted (step 515). If the safety saw system includes a camera system with camera 170 and colored gloves, the safety saw system 400 may also check whether camera system is determined to be working in step 509, and may also determine whether a drive of the camera system is faulted in step 515.

If a drive of the saw 100 is determined faulted, a fault indicator red LED is set on (step 518), and the saw monitor system 410 checks whether all safeties of the saw 100 are determined working (step 521). If no drives are determined faulted, the safety saw system 410 simply checks whether all safeties of the saw 100 are determined to be working (step 521).

If the saw monitor system 410 determines that not all safeties of the saw 100 are working, the fault indicator red LED is turned on, if not already on, (step 524) and the process loops until all safeties of the saw 100 are determined to be working (step 521).

As illustrated in FIG. 16B, once all the safeties are determined working, the saw monitor system 410 determines whether the conductive and metal detection aspects of the gloves 332 are detected (steps 527 and 530, respectively). For example, the impedance & user ID monitor 419 may detect whether a signal is outputted from the glove system 350. Also, the processor 412 may detect whether one of the gloves 332 is detected by metal detection system 900. If one of the conductive and metal detection aspects of the gloves 331 is not detected, a yellow LED is lit (steps 533 and 536, respectively) and the process loops until the aspects are detected. Although not shown in FIG. 16B, the saw monitor system 410 may also detect, with the processor 412, whether camera image data includes at least one of the colored gloves 331 when the safety saw system includes colored gloves 331 and a camera system with camera 170. Similarly, if at least one of the colored gloves 331 is not detected, a yellow LED may be lit and the process loops until at least one of the colored gloves 331 is detected.

Once the conductive and metal detection aspects of the gloves 332 (and, in some cases, the presence of the colored gloves 331) are detected, a blade guard may be lifted (step 539), and the saw monitor system 410 determines whether a stop button of the manual controls 426 is working (step 542). If no stop button input is received by the control system 413, the fault indicator red LED is turned on (step 545). If a stop button input is received, the saw monitor system 410 then determines whether an input is received by the control system 413 from a start button of the manual controls 426 (step 548).

As long as no input from the start button is received, the yellow led is turned to flashing, thereby signaling the saw 100 is idol (step 551). Once an input from the start button is received, the control system 413 controls the saw controller 415 to turn on the motor 133, and a green LED is turned on (step 554). Following, the startup process is ended.

The above-mentioned red, yellow, and green LEDs are not limited to their respective colors and may be any color. Further, the status indicators 140 may be formed to include the above-mentioned LEDs.

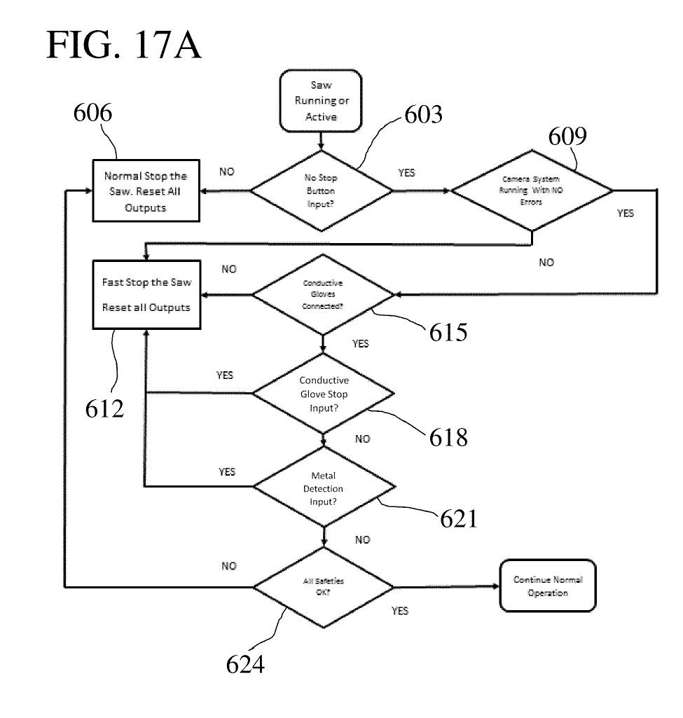

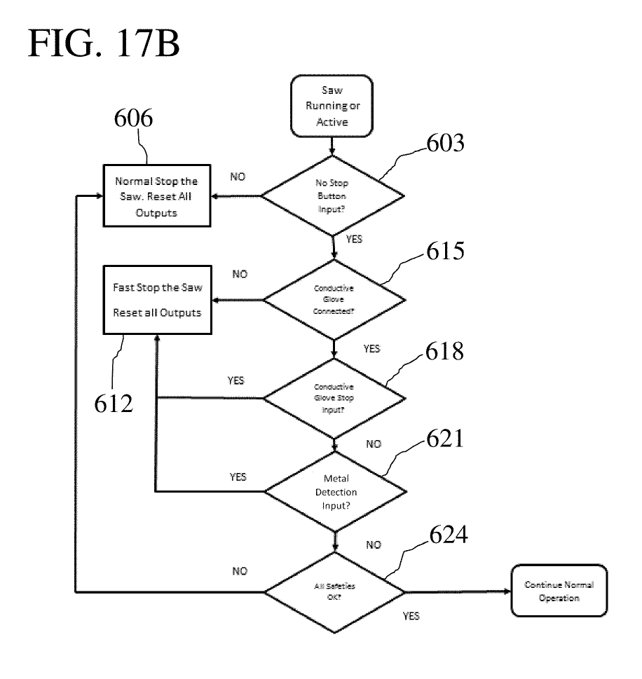

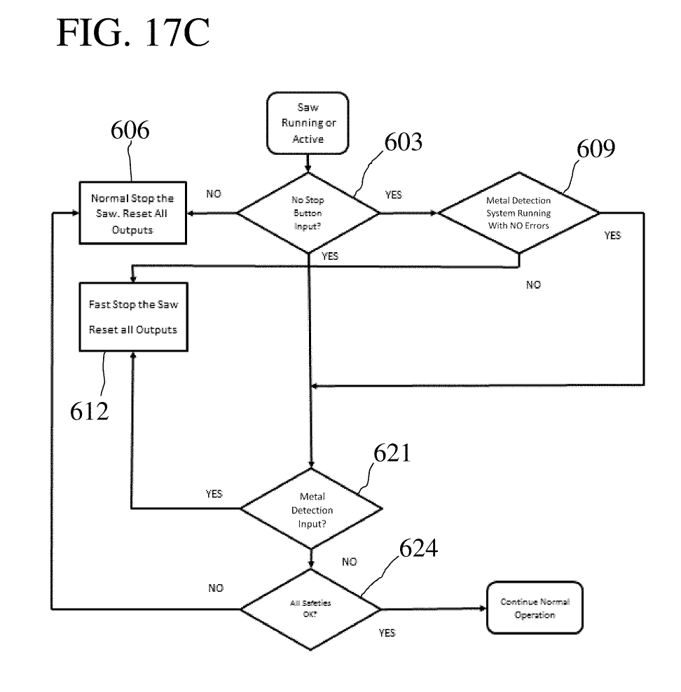

With reference to FIGS. 17A-C, example operations of the safety saw system 400 after the saw 100 is started is described.

With reference to FIG. 17A, the saw monitor system 410 checks whether an input from the stop button is received by the control system 413 (step 603). If a stop button input is received, the saw monitor system 410 causes a normal stop of the saw 100 and all outputs are reset (step 606). If no stop button input is received, the processor 412 determines whether the metal detection system 900 is working with no errors (step 609). Although not shown in FIG. 17A, the processor 412 may alternatively or additionally determine at this time whether the camera system including the camera 170 is working with no errors when included in the safety saw system 400.

If the metal detection system 900 (or the camera system, in certain cases) is determined to not be working due to errors, the saw monitor system 410 causes a fast stop of the saw 100 and all outputs are reset (step 612). If the metal detection system 900 (and the camera system, in certain cases) is determined to be working with no errors, the saw monitor system 410 determines whether the conductive gloves 332 are connected to the saw monitor system 410 (step 615). For example, the impedance & user ID monitor 419 may detect whether a signal is outputted from the glove system 350.

If at least one of the conductive gloves 332 are determined to not be connected, the saw monitor system 410 causes a fast stop of the saw 100 and all outputs are reset (step 612). Otherwise, the saw monitor system 410 determines whether a stop input is received by the impedance & user ID monitor 419 from the glove system 350 (step 618). For example, the glove system 350 may output a stop signal if one of the gloves 332 in the glove system 350 touches the blade 110.

If a stop input is received, the saw monitor system 410 causes a fast stop of the saw 100 and all outputs are reset (step 612). Otherwise, the saw monitor system 410 determines whether a metal detection input is received by the processor 412 from the metal detection system 900 that indicates a stop condition (step 621). For example, the processor 412 may determine whether one of the gloves 332 enters within an entry way to the blade 110. Although not shown in FIG. 17A, the processor 412 may alternatively or additionally determine at this time whether a camera detection input is received by the processor 412 from the camera 170 that indicates a stop condition. For example, the processor 412 may determine whether one of the gloves 330 enters within the safety zone 325.

If the metal detection input (or the camera detection input, in some cases) is received, the saw monitor system 410 causes a fast stop of the saw 100 and all outputs are reset (step 612). Otherwise, the saw monitor system 410 may determine whether all safeties of the safety saw system 400 are OK (step 624).

If at least one of the safeties of the safety saw system 400 is not OK, the saw monitor system 410 causes a normal stop of the saw 100 and all outputs are reset (step 606). Otherwise, normal operation continues. The saw may function normally until stopped with a shutoff such as, for example, pressing of a stop button of the buttons 150, as illustrated in FIG. 1, or kicking of an emergency kick stop. When normal or fast stop occurs, the control system 413 controls the saw controller 415 to turn off the motor 133, and the front guard 142 and the back guard 144 may be automatically lowered.

With reference to FIGS. 17B-C, alternative example operations of the safety saw system 400 after the saw 100 is started is described. As illustrated in FIG. 17B, the saw monitor system 410 does not determine whether the metal detection system 900 and the camera system including the camera 170 is working with no errors. As illustrated in FIG. 17C, the saw monitor system 410 does not check whether the conductive gloves 332 are connected to the saw monitor system 410, and further does not check whether a stop input is received by the impedance & user ID monitor 419 from the glove system 350. Also, it is noted that FIG. 17A describes a particular order of steps 615, 618, and 621. However, steps 615, 618, and 621 may be in any order in an embodiment.

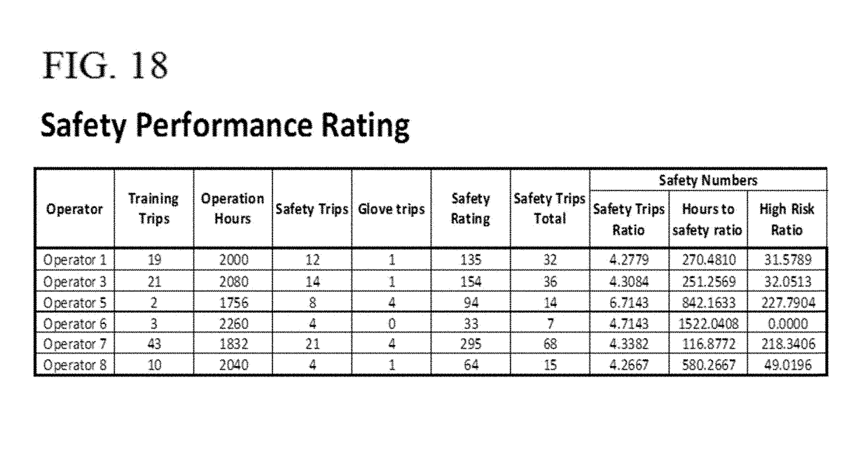

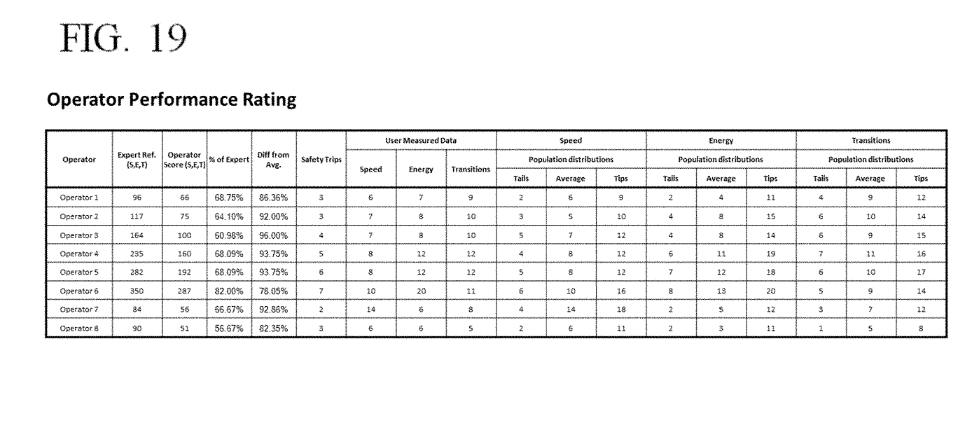

As the saw 100 runs, the safety saw system 400 may record operator statistics enabling tracking of performance, safety, and fatigue statistics. FIGS. 18 and 19 illustrate information of zones and performance that may be recorded by a safety saw system for performance and safety rating purposes.

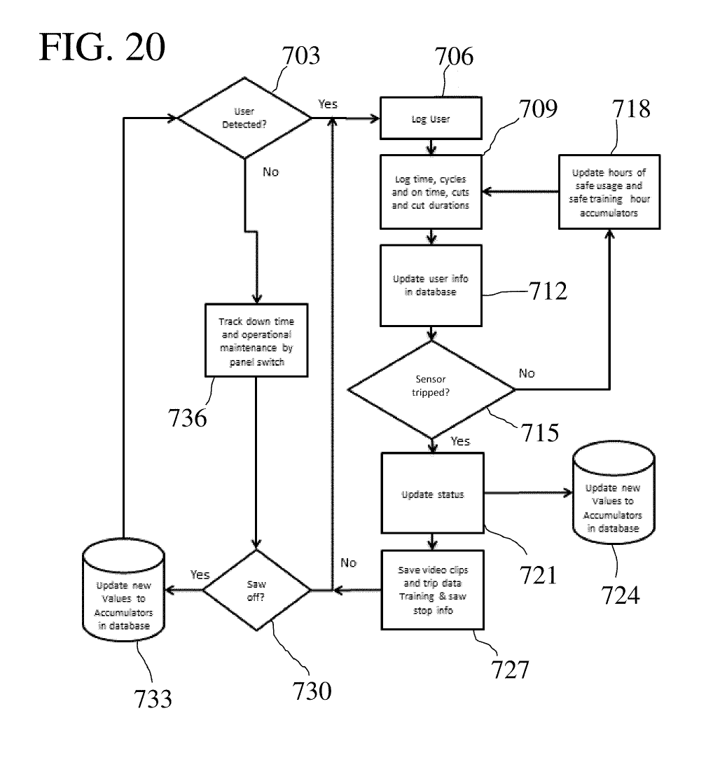

With reference to FIG. 20, a data tracking method of the safety saw system 400 is described which performs identifying and storing user information for a user ID in conjunction with both training information and saw stop information to build safety and performance statistics for the saw monitor system 410 and the user.

The saw monitor system 410 may determine whether a user of a glove system, such as glove system 350, is detected (step 703). If no user is detected, when the guard is down and the system is idle, the control system 413 may accumulate the time the saw 100 is not in use by time of day buckets for statistics (e.g. 10-ham 10 minutes 22 seconds). The switches on the access panels and guards may be used to track maintenance and cleaning times and the accumulator's may also track these times for maintenance and cleaning by tracking various inputs on the access panels and guards (step 736). Following, the saw monitor system 410 may determine whether the saw 100 is off (step 630). If a user is detected, the user is logged (step 706); the time of logging, cycles and on time of the safety saw system 400 during the user's operation of the safety saw system 400, and cuts and cut durations of the saw 100 by the user are logged (step 709); and such information of the user is updated in a database (step 712). The database may be provided in the memory of the saw monitor system 410 or externally in, for example, a cloud computing environment or an externally provided memory device.

Following, the saw monitor system 410 may determines whether a saw sensor is tripped (step 715). For example, the saw monitor system 410 may determine that a metal detection sensor is tripped when a metal detection is is received by the processor 412 from the metal detection system 900 that indicates a stop condition. Alternatively or additionally, the saw monitor system 410 may determine that a vision sensor is tripped when a camera detection input is received by the processor 412 from the camera 170 that indicates a stop condition. Further, the saw monitor system 410 may determine a saw sensor is tripped when a stop input is received by the impedance & user ID monitor 419 from the glove system 350.

If no saw sensor is determined tripped, the saw monitor system 410 may update hours of safe usage and safe training hour accumulators for the user (step 718). Following, the saw monitor system 410 returns to step 709.

If at least one saw sensor is determined tripped, the saw monitor system 410 may update a status of the user in the database (step 721). For example, the saw monitor system 410 may record information concerning the user's interactions with safety zone 325 and training zone 327 and information concerning the gloves 330 when they touch the blade 110 of the saw 100. The saw monitor system 410 may then store values of such information to accumulators within the database (step 724). The saw monitor system 410 may also save video clips, vision or saw sensor trip data, and saw stop information within the memory of the saw monitor system 410, or externally in, for example, a cloud computing environment or an externally provided memory device (step 727).

Following, saw monitor system 410 may determine whether the saw 100 is off (step 730). If the saw 100 is determined off, the saw monitor system 410 may then store values of operation information to accumulators within the database (step 733) and return to step 703. If the safety saw 110 is determined on, the saw monitor system 410 returns to step 706.

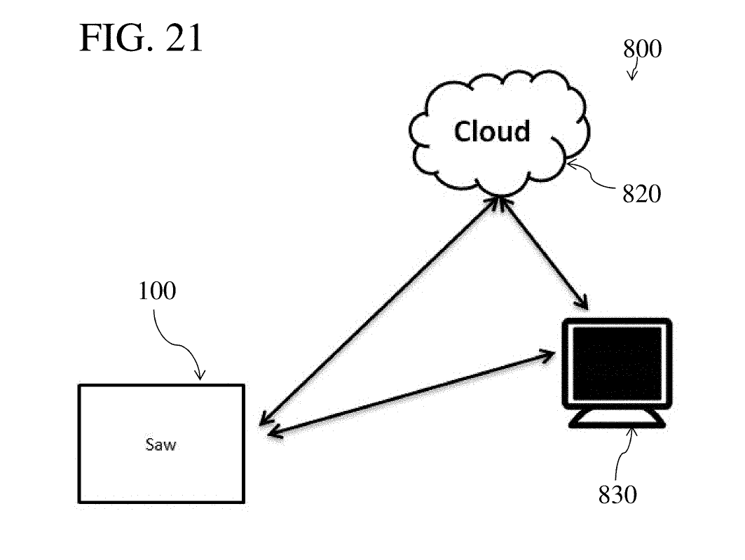

FIG. 21 illustrates an embodiment of a saw system 800 that includes the saw 100 that has connectivity to a cloud computing environment 820 and a display device 830.

Monitoring the performance statistics is very productive when the data is gathered from many sites. For example, site data can be compared and become valuable to a larger population of users. The safety and performance data as shown in FIG. 18 and FIG. 20 enable ranking and safety ratings for operators. Such data may be collected by the saw system 800. The saw 100 may be IP addressable and have Ethernet and WiFi capability. The saw 100 may be controlled by an attached computer such as a CPU with memory, such as ROM or RAM having computer executable instructions written therein. Alternatively, the saw 100 may be controlled by computing resources distributed in a cloud computing environment 820. The cloud based statistics and training enable an application on a display device 830, such as a PC, mobile device, or tablet, to show each manager the operator data for evaluations, training and propensity for safe operation. All together this enables a safer saw, a safer environment, informed management, informed operators and overall method of safe operating ecosystem.

A network of processing equipment that communicates through a network together and track performance and assets running. Saw blade hours of usage, replacement times and preventive maintenance for replaceable items and repair. Even cleaning times can be tracked. Pushing information up to the cloud for reporting and service models.

Additionally, because the entire drive system and braking system of an embodiment of the present disclosure may be electronic, a saw may be restarted quickly after an automatic-stop is triggered. For example, after an automatic-stop event, an operator may need only to push a button to reset the system, confirm that safety systems are working by, for example, showing a glove to a camera or having it be detected by a metal detection system, and resume cutting. It is emphasized that due to the rapid stopping time, the blade of the saw is not significantly damaged even though it may make physical contact with the conductive glove.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

It should be noted that although a few embodiments have been described, those skilled in the art will readily appreciate that many modifications are possible to embodiments of the present disclosure without materially departing from the novel teachings and advantages of the embodiments. Accordingly, all such modifications are intended to be included within the scope of the embodiments as shall be defined in the claims. Therefore, it is to be understood that the foregoing is illustrative of various embodiments and is not to be construed as limited to the specific example embodiments disclosed.

Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A saw system comprising:
a saw comprising:
a saw blade configured for cutting, the saw blade including at least one hole that is filled with a weight-reduction insert;
a shaft connected to the saw blade;
a motor configured to rotate the saw blade by rotating the shaft;
at least one processor configured to control the motor; and
a detector configured to detect when a body part of a person is adjacent to or touching the saw blade, wherein
the at least one processor is configured to control the motor to stop rotation of the saw blade in response to the detector detecting that the body part is adjacent to or touching the saw blade.

2. The saw system of claim 1, wherein
the detector is a metal detector having a metal detection area in a location where a hand may travel towards the saw blade, the metal detector configured to send an output signal to the at least one processor, based on presence of metal in the metal detection area of the metal detector,
the saw system further comprises a glove comprising metal that is detectable by the metal detector when the glove is present in the metal detection area of the metal detector, and
the at least one processor is configured to control the motor to stop rotation of the saw blade, before the glove contacts the saw blade, in response to the metal of the glove being detected by the metal detector.

3. The saw system of claim 2, wherein
the glove comprises a conductive glove layer that is electrically connected to the at least one processor,
the saw blade is electrically isolated from an electrical ground on a pathway through the saw,
the glove and the saw blade are configured to, in response to the glove contacting the saw blade, complete an electrical circuit that includes a pathway through the saw blade and the glove, and
the at least one processor is configured to control the motor to stop rotation of the saw blade in response to the electrical circuit being completed.

4. The saw system of claim 3, wherein
the at least one processor is configured to determine that the glove is on a body of a person by reading an electrical resistance of the body.

5. The saw system of claim 3, further comprising:
a camera directed at a cutting area of the saw blade and configured to send image data to the at least one processor, wherein
the glove further comprises a colored glove layer, the colored glove layer configured to surround the conductive glove layer, and
the at least one processor is further configured to detect the colored glove layer in the image data sent by the camera, and control the motor to stop rotation of the saw blade in response to the colored glove layer being detected within a predetermined area of the image data.

6. The saw system of claim 5, wherein the colored glove layer has a green color.

7. The saw system of claim 5, wherein the colored glove layer is an electrically insulating glove layer.

8. The saw system of claim 7, wherein the electrically insulating glove layer has an electrical resistance that is lower than an electrical resistance of a body of a person or lower than an electrical resistance of meat that the saw blade is configured to cut.

9. The saw system of claim 1, wherein the shaft is hollow.

10. The saw system of claim 1, wherein the motor is a direct-drive motor, and the motor is further configured to stop the saw blade in less than 20 ms.

11. A method of stopping a saw including a saw blade configured for cutting, a shaft connected to the saw blade, a motor configured to rotate the saw blade by rotating the shaft, and at least one processor configured to the control the motor, the method comprising:
detecting, with a detector, a body part of a person that is adjacent to or touching the saw blade, and
controlling, with the at least one processor, the motor to stop rotation of the saw blade, in response to the detector detecting that the body part is adjacent to or touching the saw blade, wherein
the saw blade includes at least one hole that is filled with a weight-reduction insert.

12. The method of claim 11, wherein
the detector is a metal detector having a metal detection area in a location where a hand may travel towards the saw blade,
the detecting comprises detecting, with the metal detector, a glove comprising metal that is present in the metal detection area of the metal detector, and
the controlling comprises controlling, with the at least one processor, the motor to stop rotation of the saw blade before the glove contacts the saw blade, in response to the metal of the glove being detected by the metal detector.

13. The method of claim 12, wherein
the glove comprises a conductive glove layer that is electrically connected to the at least one processor,
the saw blade is electrically isolated from an electrical ground on a pathway through the saw,
the glove and the saw blade are configured to, in response to the glove contacting the saw blade, complete an electrical circuit that includes a pathway through the saw blade and the glove, and
the method further comprising controlling, with the at least one processor, the motor to stop rotation of the saw blade in response to the electrical circuit being completed.

14. The method of claim 13, further comprising:
determining, with the at least one processor, that the glove is on a body of a person by reading an electrical resistance of the body.

15. The method of claim 13, wherein
the glove further comprises a colored glove layer, the colored glove layer configured to surround the conductive glove layer, and
the method further comprising:
sending, with a camera directed at a cutting area of the saw blade, image data to the at least one processor;
detecting, with the at least one processor, the colored glove layer in the image data sent by the camera; and
controlling, with the at least one processor, the motor to stop rotation of the saw blade in response to the colored glove layer being detected within a predetermined area of the image data.

16. The saw system of claim 15, where the colored glove layer has a green color.

17. The method of claim 15, wherein the colored glove layer is an electrically insulating glove layer.

18. The method of claim 17, wherein the electrically insulating glove layer has an electrical resistance that is lower than an electrical resistance of a body of a person or lower than an electrical resistance of meat that the saw blade is configured to cut.

19. The method of claim 11, wherein the shaft is hollow.

20. The method of claim 11, wherein the motor is a direct-drive motor, and the motor is further configured to stop the saw blade in less than 20 ms.
